(19) United States
(12) Patent Application Publication
(10) Pub. No.: US 2014/0357274 A1
(43) Pub. Date: Dec. 4, 2014

(54) CELL HANDOVERS

(71) Applicants: Yong Teng, Beijing (CN); Kari Veikko Horneman, Oulu (FI); Bin Chen, Shanghai (CN); Jiang Wang, Shanghai (CN); Jing Xu, Shanghai (CN)

(72) Inventors: Yong Teng, Beijing (CN); Kari Veikko Horneman, Oulu (FI); Bin Chen, Shanghai (CN); Jiang Wang, Shanghai (CN); Jing Xu, Shanghai (CN)

(73) Assignee: NOKIA SOLUTIONS AND NETWORKS OY, Espoo (FI)

(21) Appl. No.: 14/372,508

(22) PCT Filed: Jan. 20, 2012
(86) PCT No.: PCT/CN2012/070687

§ 371 Date: Jul. 16, 2014

(51) Int. Cl. H04W 36/00

(52) U.S. Cl. CPC H04W 36/0094
USPC 455/436

(57) ABSTRACT

A technique includes: comparing (a) measurements made at the first access node of transmissions made by a plurality of other access nodes against (b) measurements made at the communication device of transmissions made by said plurality of other access nodes; and deciding whether or not to select said first access node as a handover candidate for said communication device based at least partly on the result of said comparison.

The operation of a cellular network typically involves handovers of a communication device from one cell to another cell.

Examples of telecommunication services provided by a cellular network to a communication device include communication of voice, electronic mail (email), text messages, data, multimedia etc.

A cellular network typically operates in accordance with a wireless standard. Examples include GSM (Global System for Mobile) EDGE (Enhanced Data for GSM Evolution) Radio Access Networks (GERAN), Universal Terrestrial Radio Access Networks (UTRAN), and evolved Universal Terrestrial Radio Access Networks (EUTRAN).

Conventionally, the selection of a cell as a potential handover candidate for a communication device would be based at least partly on measurements made at the communication device of transmissions made by that cell.

Particularly in the case of a communication device located in an area densely populated by cells, it has been found that this technique for selecting cell as a potential handover candidate can consume significant amounts of battery power at the communication device and require increasingly significant amounts of radio resources for signalling results of the measurements made at the communication device to the cell currently serving the communication device.

There has been identified the challenge of providing a new technique for identifying cells as potential handover candidates for a communication device.

There is hereby provided a method comprising: comparing (a) measurements made at the first access node of transmissions made by a plurality of other access nodes against (b) measurements made at the communication device of transmissions made by said plurality of other access nodes; and deciding whether or not to select said first access node as a handover candidate for said communication device based at least partly on the result of said comparison.

According to one embodiment, said plurality of other access nodes operate at the same group of transmission frequencies as an access node currently serving the transmission device, and said first access node operates at a group of transmission frequencies different to that of said access node currently serving said communication device.

There is also hereby provided a method comprising: making measurements at a first access node of transmissions made by a plurality of other access nodes; and sending information about said measurements to one or more other network nodes for use in determining the proximity of said first access node to a communication device.

According to one embodiment, the method further comprises: also sending from said first access node to said one or more other network nodes information about the transmission frequencies employed by said first access node and closed subscriber group (CSG) related parameters about said first access node if said first access node happens to belong to a CSG.

According to one embodiment, said plurality of other access nodes operate at the same group of transmission frequencies as an access node currently serving the transmission device, and said first access node operates at a group of transmission frequencies different to that of said access node currently serving said communication device.

According to one embodiment, the method further comprises: sending from said first access node to said one or more other network nodes an advance indication that the first access node will become unavailable as a potential handover target.

There is also hereby provided a method comprising: receiving at a communication device information about measurements made at a first access node of transmissions made by a plurality of other access nodes, and making measurements at said communication device of transmissions made by said plurality of other access nodes; and deciding whether to select said first access node as a handover candidate for said communication device based at least partly on a comparison of said measurements made at a first access node and said measurements made at said communication device.

There is also hereby provided a method comprising: making at a communication device measurements of transmissions made by a plurality of access nodes identified in a request received from an access node serving said communication device; transmitting information about said measurements to said access node serving said communication device for use in determining the proximity of said communication device to a first access node not included in said plurality of access nodes.

According to one embodiment, said plurality of access nodes operate at the same group of transmission frequencies as an access node currently serving the transmission device, and said first access node operates at a group of transmission frequencies different to that of said access node currently serving said communication device.

There is also hereby provided a method comprising: receiving information about measurements made at a communication device of transmissions made by at least an access node serving said communication device, and receiving information about measurements made at a first access node of transmissions made by at least said serving access node; and based at least partly on a comparison of said measurements made at said communication device and said measurements made at said first access node, deciding whether to provide communication device with information for determining proximity of said communication device to said first access node.

According to one embodiment said first access node operates at a group of transmission frequencies different to that of said access node serving said communication device.

There is also hereby provided a method comprising: receiving information about measurements made at a communication device of transmissions made by a plurality of access nodes, and receiving information about measurements made at a first access node of transmissions made by said plurality of access nodes; and based at least partly on a comparison of said measurements made at said communication device and said measurements made at said first access node, deciding whether to provide said communication device with information for making handover measurements in relation to said first access node.

According to one embodiment, said plurality of access nodes operate at the same group of transmission frequencies as an access node currently serving the transmission device, and said first access node operates at a group of transmission frequencies different to that of said access node currently serving said communication device.

There is also hereby provided apparatus comprising: a processor and memory including computer program code, wherein the memory and computer program code are configured to, with the processor, cause the apparatus to: compare (a) measurements made at the first access node of transmissions made by a plurality of other access nodes against (b) measurements made at the communication device of transmissions made by said plurality of other access nodes; and decide whether or not to select said first access node as a handover candidate for said communication device based at least partly on the result of said comparison.

According to one embodiment, said plurality of other access nodes operate at the same group of transmission frequencies as an access node currently serving the transmission device, and said first access node operates at a group of transmission frequencies different to that of said access node currently serving said communication device.

There is also hereby provided an apparatus comprising: a processor and memory including computer program code, wherein the memory and computer program code are configured to, with the processor, cause the apparatus to: make measurements at a first access node of transmissions made by a plurality of other access nodes; and send information about said measurements to one or more other network nodes for use in determining the proximity of said first access node to a communication device.

According to one embodiment, the memory and computer program code are further configured to, with the processor, cause the apparatus to: also send from said first access node to said one or more other network nodes information about the transmission frequencies employed by said first access node and closed subscriber group (CSG) related parameters about said first access node if said first access node happens to belong to a CSG.

According to one embodiment, said plurality of other access nodes operate at the same group of transmission frequencies as an access node currently serving the transmission device, and said first access node operates at a group of transmission frequencies different to that of said access node currently serving said communication device.

According to one embodiment, the memory and computer program code are further configured to, with the processor, cause the apparatus to: send from said first access node to said one or more other network nodes an advance indication that the first access node will become unavailable as a potential handover target.

There is also hereby provided an apparatus comprising: a processor and memory including computer program code, wherein the memory and computer program code are configured to, with the processor, cause the apparatus to: receive at a communication device information about measurements made at a first access node of transmissions made by a plurality of other access nodes, and make measurements at said communication device of transmissions made by said plurality of other access nodes; and decide whether to select said first access node as a handover candidate for said communication device based at least partly on a comparison of said measurements made at a first access node and said measurements made at said communication device.

There is also hereby provided an apparatus comprising: a processor and memory including computer program code, wherein the memory and computer program code are configured to, with the processor, cause the apparatus to: make at a communication device measurements of transmissions made by a plurality of access nodes identified in a request received from an access node serving said communication device; and transmit information about said measurements to said access node serving said communication device for use in determining the proximity of said communication device to a first access node not included in said plurality of access nodes.

According to one embodiment, said plurality of access nodes operate at the same group of transmission frequencies as an access node currently serving the transmission device, and said first access node operates at a group of transmission frequencies different to that of said access node currently serving said communication device.

There is also hereby provided an apparatus comprising: a processor and memory including computer program code, wherein the memory and computer program code are configured to, with the processor, cause the apparatus to: receive information about measurements made at a communication device of transmissions made by at least an access node serving said communication device, and receive information about measurements made at a first access node of transmissions made by at least said serving access node; and based at least partly on a comparison of said measurements made at said communication device and said measurements made at said first access node, decide whether to provide communication device with information for determining proximity of said communication device to said first access node.

According to one embodiment, said first access node operates at a group of transmission frequencies different to that of said access node serving said communication device.

There is also hereby provided an apparatus comprising: a processor and memory including computer program code, wherein the memory and computer program code are configured to, with the processor, cause the apparatus to: receive information about measurements made at a communication device of transmissions made by a plurality of access nodes, and receive information about measurements made at a first access node of transmissions made by said plurality of access nodes; and based at least partly on a comparison of said measurements made at said communication device and said measurements made at said first access node, decide whether to provide said communication device with information for making handover measurements in relation to said first access node.

According to one embodiment, said plurality of access nodes operate at the same group of transmission frequencies as an access node currently serving the transmission device, and said first access node operates at a group of transmission frequencies different to that of said access node currently serving said communication device.

There is also hereby provided a computer program product comprising program code means which when loaded into a computer controls the computer to: compare (a) measurements made at the first access node of transmissions made by a plurality of other access nodes against (b) measurements made at the communication device of transmissions made by said plurality of other access nodes; and decide whether or not to select said first access node as a handover candidate for said communication device based at least partly on the result of said comparison.

There is also hereby provided a computer program product comprising program code means which when loaded into a computer controls the computer to: make measurements at a first access node of transmissions made by a plurality of other access nodes; and send information about said measurements to one or more other network nodes for use in determining the proximity of said first access node to a communication device.

There is also hereby provided a computer program product comprising program code means which when loaded into a computer controls the computer to: receive at a communication device information about measurements made at a first access node of transmissions made by a plurality of other access nodes, and make measurements at said communication device of transmissions made by said plurality of other access nodes; and decide whether to select said first access node as a handover candidate for said communication device based at least partly on a comparison of said measurements made at a first access node and said measurements made at said communication device.

There is also hereby provided a computer program product comprising program code means which when loaded into a computer controls the computer to: make at a communication device measurements of transmissions made by a plurality of access nodes identified in a request received from an access node serving said communication device; and transmit information about said measurements to said access node serving said communication device for use in determining the proximity of said communication device to a first access node not included in said plurality of access nodes.

There is also hereby provided a computer program product comprising program code means which when loaded into a computer controls the computer to: receive information about measurements made at a communication device of transmissions made by at least an access node serving said communication device, and receive information about measurements made at a first access node of transmissions made by at least said serving access node; and based at least partly on a comparison of said measurements made at said communication device and said measurements made at said first access node, decide whether to provide communication device with information for determining proximity of said communication device to said first access node.

There is also hereby provided a computer program product comprising program code means which when loaded into a computer controls the computer to: receive information about measurements made at a communication device of transmissions made by a plurality of access nodes, and receive information about measurements made at a first access node of transmissions made by said plurality of access nodes; and based at least partly on a comparison of said measurements made at said communication device and said measurements made at said first access node, decide whether to provide said communication device with information for making handover measurements in relation to said first access node.

There follows hereunder a detailed description of examples of the techniques mentioned above, with reference to the accompanying drawings, in which:

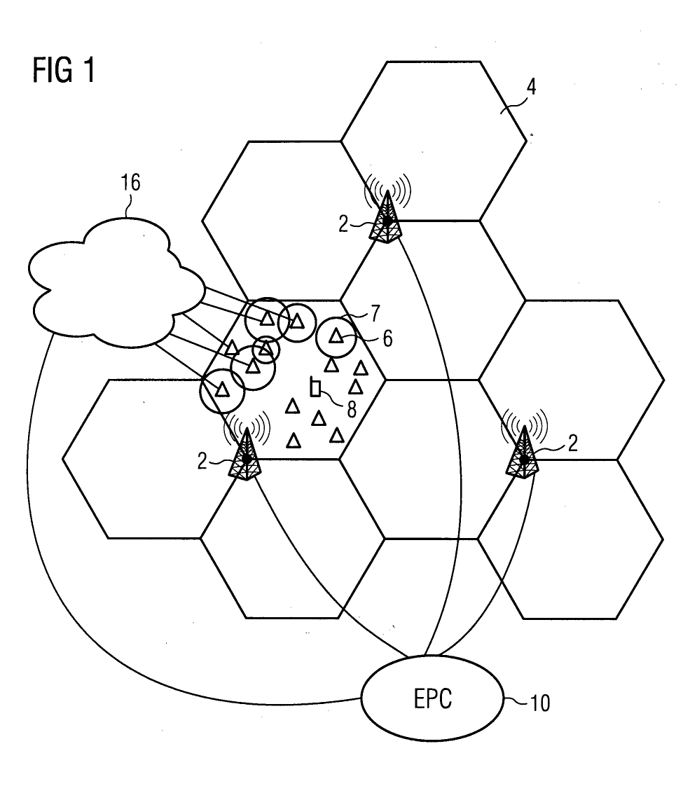

FIG. 1 illustrates an example of a cellular network involving macro cells and small cells;

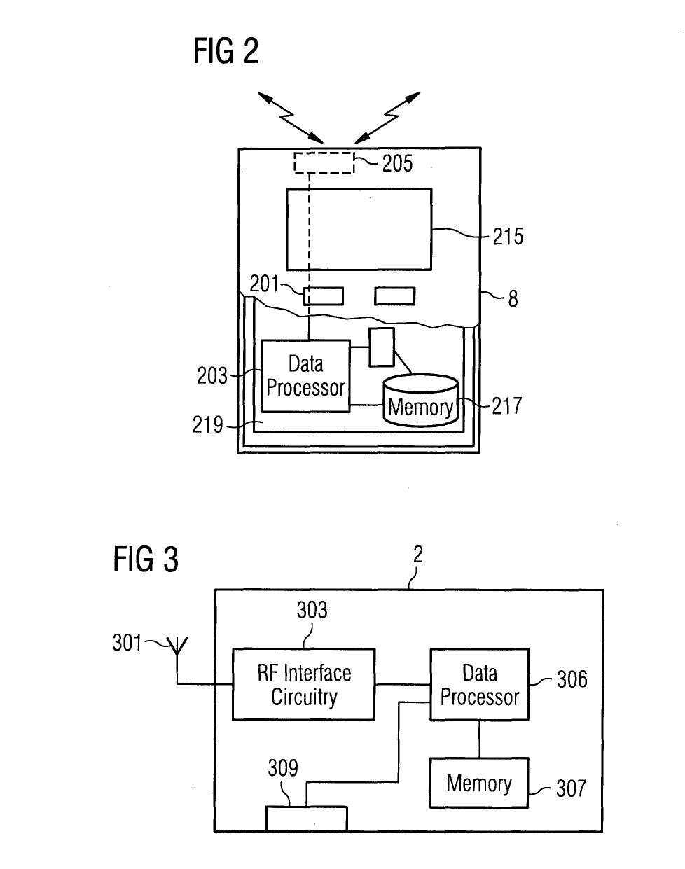

FIG. 2 schematically illustrates an example of user equipment operable in the network of FIG. 1;

FIG. 3 schematically illustrates an example of an apparatus suitable for use at the macro cells and small cells of FIG. 1;

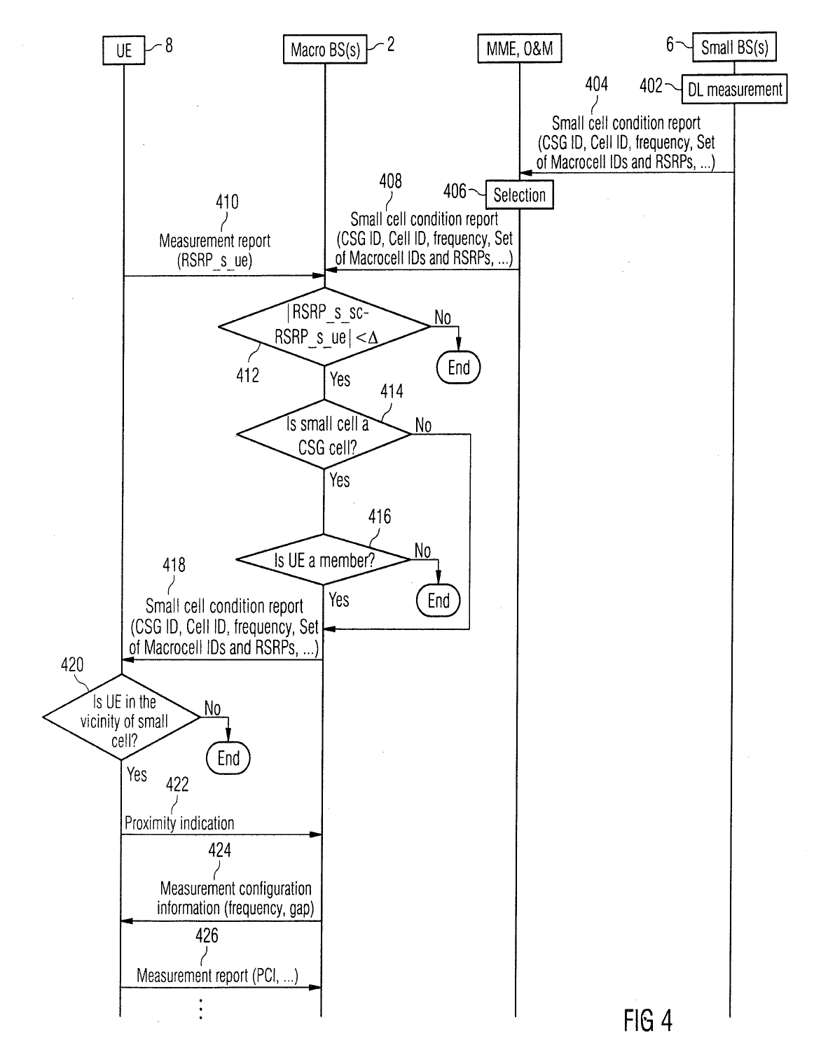

FIG. 4 is a flowchart illustrating a technique according to an embodiment of the invention.

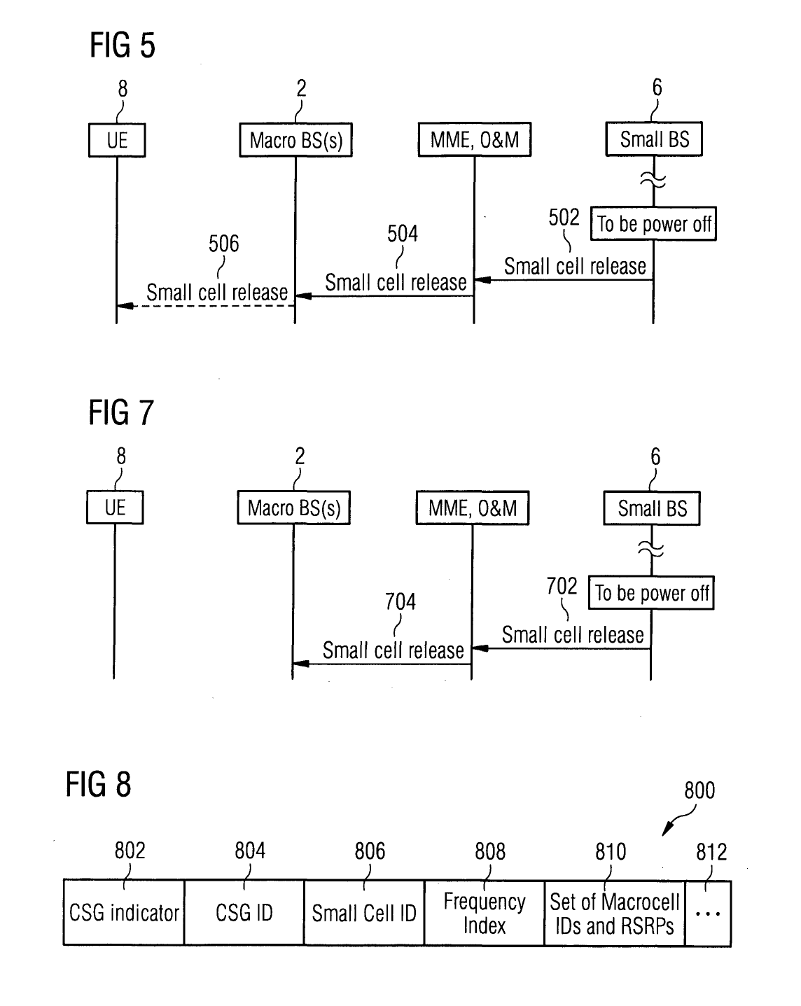

FIG. 5 is a flowchart illustrating additional messaging in the event of the deactivation or shutdown of a small cell.

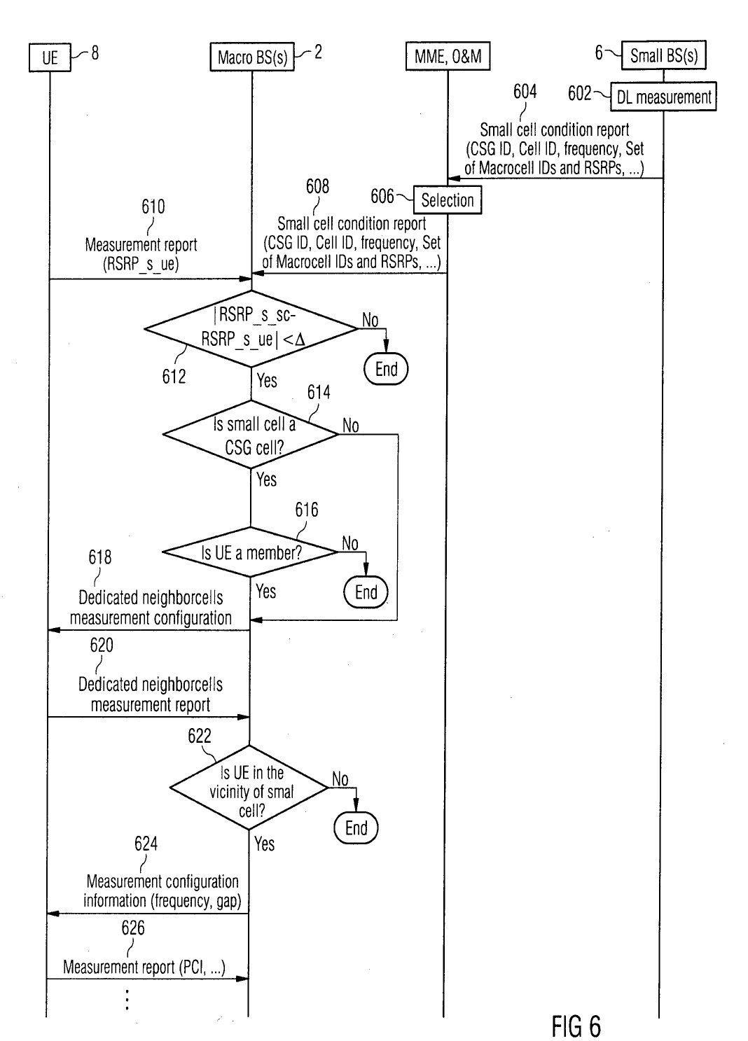

FIG. 6 is a flow chart illustrating a technique according to another embodiment of the present invention.

FIG. 7 is a flowchart illustrating additional messaging in the event of the deactivation or shutdown of a small cell.

FIG. 8 is an example of a message format for sending information about reference signal measurements in the techniques of FIGS. 4 and 6.

Embodiments of the invention are described below, by way of example only, in the context of mobile telecommunication network operating in accordance with a 3GPP LTE-A (Long Term Evolution Advanced) standard and providing 3G services via cellular base stations including macro cells of relatively large coverage and small cells of smaller coverage. However, the same kind of techniques are also of use in other kinds of mobile telecommunication networks comprising macro service areas dotted with localised service areas.

FIG. 1 illustrates an example of a mobile telecommunication network (MTN) involving macro cells 4 with transceivers at respective macro eNodeBs (eNBs) and small cells 7 with transceivers at respective small cell NBs 6. In FIG. 1, the triangular elements designate small cell NBs 6. For clarity purposes, only some small cells 7 are illustrated by circles centred on the respective NB 6, but each of the small cell NBs 6 serves a respective small cell.

Only nine macro cells are shown in FIG. 1, but a mobile telecommunication network will typically comprise tens of thousands of macro cells. Only one of the macro cells is shown as being dotted with small cells, but the other macro cells are also similarly dotted with small cells.

Each macro cell NB 2 is connected to an Evolved Packet Core 10 by an S1 fixed link.

The small cell NBs 6 are connected to the Evolved Packet Core 10 using, for example, either (i) a broadband IP (Internet Protocol) backhaul via the Internet 16 or (ii) a link via a macro cell NB 2 using a fixed X2 interface or wireless interface between the small cell NB and the macro cell NB. Typically, the macro cell NBs can share groups of transmission frequencies because of the relatively large physical distance between the macro NBs, but the small cell NBs are generally required to use different groups of transmission frequencies to those used by the macro cell NBs in order to avoid excessive interference between transmissions to and from the macro NBs and transmissions to and from the small cell NBs.

FIG. 2 shows a schematic partially sectioned view of an example of user equipment 8 that may be used for communicating with the macro NBs 2 and small cell NBs 6 of FIG. 1 via a wireless interface. The user equipment (UE) 8 may be used for various tasks such as making and receiving phone calls, for receiving and sending data from and to a data network and for experiencing, for example, multimedia or other content.

The UE 8 may be any device capable of at least sending or receiving radio signals to or from the macro NBs 2 and small cell NBs 6. Non-limiting examples include a mobile station (MS), a portable computer provided with a wireless interface card or other wireless interface facility, personal data assistant (PDA) provided with wireless communication capabilities, or any combinations of these or the like. The UE 8 may communicate via an appropriate radio interface arrangement of the UE 8. The interface arrangement may be provided for example by means of a radio part and associated antenna arrangement. The antenna arrangement may be arranged internally or externally to the UE 8.

The UE 8 may be provided with at least one data processing entity 203 and at least one memory or data storage entity 217 for use in tasks it is designed to perform. The data processor 213 and memory 217 may be provided on an appropriate circuit board 219 and/or in chipsets.

The user may control the operation of the UE 8 by means of a suitable user interface such as key pad 201, voice commands, touch sensitive screen or pad, combinations thereof or the like. A display 215, a speaker and a microphone may also be provided. Furthermore, the UE 8 may comprise appropriate connectors (either wired or wireless) to other devices and/or for connecting external accessories, for example hands-free equipment, thereto.

FIG. 3 shows an example of apparatus for use at the small cell NBs 6 and macro NBs 2. The apparatus comprises a radio frequency antenna 301 configured to receive and transmit radio frequency signals; radio frequency interface circuitry 303 configured to interface the radio frequency signals received and transmitted by the antenna 301 and the data processor 306. The radio frequency interface circuitry 303 may also be known as a transceiver. The apparatus also comprises an interface 309 via which it can send and receive information to and from one or more other network nodes e.g. MME or O&M entity. The data processor 306 is configured to process signals from the radio frequency interface circuitry 303, control the radio frequency interface circuitry 303 to generate suitable RF signals to communicate information to the UE 6 via the wireless communications link, and also to exchange information with other network nodes via the interface 309. The memory 307 is used for storing data, parameters and instructions for use by the data processor 306.

It would be appreciated that the apparatus shown in each of FIGS. 2 and 3 and described above may comprise further elements which are not directly involved with the embodiments of the invention described hereafter.

The techniques described hereunder take advantage of the fact that both a small cell NB 6 and UE 8 can autonomously detect signals transmitted by a plurality of macro cell NBs in different locations, measure the signal strengths at which those signals are detected at the small cell NB, and send messages about the measurements to the network; and that these measurements by the UE 8 and small cell NB 6 can be used to assess the proximity of the UE 8 to the small cell NB 6.

Two examples of techniques by which such measurement information is collected and used to decide whether a small NB 6 is a good handover candidate for UE 8 are described below.

FIG. 5 illustrates a first example in which the decisive comparison of the measurements is done at the UE 8, and FIG. 7 illustrates a second example in which the decisive comparison of the measurements is done at the macro cell NB currently serving the UE 8.

With reference to FIG. 4, the first example involves the following steps.

When a small cell 6 is switched on or reset, the small cell NB 6 autonomously searches for reference signals transmitted by macro cell NBs 2 and records the macro cell IDs (which IDs are derivable from the reference signals transmitted by the macro cell NBs) and corresponding received signal strength (reference signal received power (RSRP)) for any macro cell NBs that it detects (STEP 402). For simplicity, only one small cell 6 is shown in FIG. 4, but as mentioned above the network will typically include a large number of other small cells 6.

The small cell 6 uses the broadband IP (Internet Protocol) backhaul via the Internet 16 to send information about the results of its measurements of macro cell reference signals to a management entity (such as a Mobility Management Entity (MME) or Operation and Maintenance Server (O&M)) of the Evolved Packet Core 10 together with information about the small cell 6 (STEP 404). This can be achieved using a small cell condition report message 800 having the kind of format shown in FIG. 8. The small cell condition report message 800 includes a field 802 to indicate whether or not the small cell belongs to a closed subscriber group (CSG); a field 804 to indicate the identifier for the CSG to which the small cell belongs (if any); a field 806 to indicate a cell identifier (physical cell identifier PCI) for the small cell; a field 808 to include a frequency index indicating the working frequency of the small cell; a field 810 for including information about the identity ID of macro cells detected at the small cell and information about the strength (e.g. RSRP) at which their reference signals are detected at the small cell; and a field 812 for other relevant parameters.

When the small cell 6 changes its working frequency or physical cell identifier (PCI), it resends this small cell condition report message 800 to the MME or O&M with updated content.

According to one variation, the small cell 6 may directly send this kind of small cell condition report message 800 to one or more of the detected macro cell NBs via fixed X2 interfaces or wireless interfaces with those macro cell NBs.

Based on the RSRP values included in the small cell condition report message 800 received from the small cell 6 in STEP 404, the MME or O&M selects one or more of the detected macro cells 2 to which to forward the small cell condition report message 800 (STEP 406). The selected macro cells 2 are those for which the probability of a handover of the UE to the small cell is determined by the MME or O&M to meet a predetermined threshold value.

The MME or O&M forwards the small cell condition report message 800 to the selected macro cell NBs 2 via the fixed S1 links to those macro cell NBs 2 (STEP 408).

In the above-mentioned variation in which the small cell sends the small cell condition report message directly to the macro cell NBs via fixed X2 interfaces or wireless interfaces between the small cell NB 6 and the macro cell NB 2, STEPS 406 and 408 are omitted.

Assuming that one of the selected macro cells is a macro cell that is already serving the UE 8, that serving macro cell NB will already be receiving from UE 8 periodic reports of the power at which it detects reference signals transmitted by the serving macro cell NB (RSRP_s_ue) (STEP 410).

The serving macro cell NB 2 compares the RSRP value reported by UE 8 for the serving macro cell (RSRP_s_ue) with the RSRP values (RSRP_s_sc) for the serving macro cell included in the small cell condition report messages 800 received (directly or indirectly) from one or more small cells (STEP 412). If there is no small cell whose reporting RSRP value for the serving macro cell (RSRP_s_sc) is in sufficient proximity to RSRP_s_ue, e.g., the difference between RSRP_s_sc and RSRP_s_ue is lower than a predetermined threshold value A, the process ends until there is fresh data to repeat STEP 412. If there is a small cell whose reported RSRP value for the serving macro cell is in sufficient proximity to RSRP_s_ue, the process moves to the next step. If there happens to be more than one small cell whose reported RSRP value for the serving macro cell is in sufficient proximity to RSRP_s_ue, the serving macro cell 2 selects for the next step the small cell whose reported RSRP value for the serving macro cell is most proximate to RSRP_s_ue.

Based again on the information included in the small cell condition report message 800 for the small cell that best meets the condition of STEP 412, the serving macro cell can determine whether that small cell 6 is a CSG cell or not (STEP 414). If the small cell is not a CSG cell, the process moves straight to STEP 418.

If the small cell is a CSG cell, the serving macro cell NB 2 determines whether the UE has access rights for the CSG to which the small cell belongs (STEP 416).

This involves the serving macro cell NB interacting with MME, which performs UE access control based on the CSG ID communicated to it by the serving macro cell NB and the stored CSG subscription data for the UE 8. For the sake of simplicity, this interaction between the serving macro cell NB and the MME is not shown in FIG. 4. If the UE 8 is found to have access rights to the CSG to which the small cell belongs, the process moves to STEP 418; if not, the process terminates until there is fresh data to repeat STEP 412.

In STEP 418: the serving macro cell NB 2 transmits the small cell condition report message 800 for the small cell selected at STEP 412 to UE 8 via the wireless interface between the serving macro cell NB 2 and UE 8.

After receiving the small cell condition report message 800, UE 8 makes measurements of the power at which it receives reference signals from the macro cells identified in the small cell condition report message 800 received from the serving macro cell NB 2. By comparison of the RSRPs measured at UE 8 and the RSRP information included in the small cell condition report message 800, UE 8 can determine whether UE 8 is in the vicinity of the small cell 6 (STEP 420). This comparison may be realized by using a predetermined algorithm. If the comparison result shows that UE 8 is in the vicinity of the small cell, the process moves to the next step; otherwise, UE 8 rejects the small cell as a potential handover candidate.

If UE 8 determines that it is indeed in the vicinity of the small cell 6, UE 8 transmits an “entering” proximity indication to the serving macro cell NB 2 (STEP 422). The proximity indication includes an indication of the radio access technology (RAT) and working frequency for the small cell 6.

In reply, the serving macro cell NB 2 transmits a measurement configuration message to the UE 8 including any necessary indication of measurement gaps for the small cell determined to be in the vicinity of UE 8 (STEP 424).

UE 8 makes measurements of transmissions made by the small cell for which it has received said measurement configuration message from the serving macro cell NB 2, and in response to a handover triggering event (A3 event), UE 8 transmits to the serving macro cell NB 2 a measurement report including an indication of a physical cell identifier (PCI) (STEP 426); and the handover procedure continues in the conventional way.

In the event that a small cell NB 6 is to be shut down or deactivated, then as shown in FIG. 5, that small cell NB automatically sends a small cell release message in advance to the MME or O&M via the backhaul link (STEP 502). The small cell release message at least includes the cell global ID of the small cell. It may also include other information that should be sent to MME or O&M and, as mentioned below, relevant macro cell NBs 2. The MME or O&M forwards the small cell release message to those macro cell NBs to which it has previously sent a small cell condition report message for the small cell to which the small cell release message relates (STEP 504). If a macro cell NB 2 that receives said small cell release message has already sent a small cell condition report message for that small cell to one or more UEs 8, that macro cell NB 2 also transmits the small cell release message to those one or more UEs for their notification (STEP 506).

With reference to FIG. 6, the technique according to a second example is the same as the technique according to the first example up to the point that the macro cell NB 2 serving UE 8 determines that there is a small cell whose reported RSRP value for the serving macro cell (RSRP_s_sc) is in sufficient proximity to the RSRP value reported by UE 8 for the serving macro cell (RSRP_s_ue), and UE 8 has the necessary access rights if that small cell happens to belong to a CSG. STEPS 602 to 616 of FIG. 6 are the same as STEPS 402 to 416 of FIG. 4, respectively.

According to the second example, the serving macro cell NB 2 next sends a dedicated neighbor cells measurement configuration message to UE 8 (STEP 618). The dedicated measurement configuration message specifies (i) measurement objects including the cell IDs and frequencies of macro cells whose reference signals are to be measured by UE 8, (ii) reporting configurations including reporting criterion and reporting format including an indication of the parameter of the reference signal that is to be measured and reported (e.g. RSRP), and (iii) any necessary measurement gaps, which are periods that UE 8 may use to make the measurements. UE 8 periodically makes these kind of macro cell reference signal measurements for other purposes (and makes reports to its serving macro cell NB if any of the measurement results meet predetermined conditions (triggering event) and in a predetermined reporting period), but the above-mentioned dedicated measurement configuration message also includes a Dedicated Indicator which indicates to UE 8 that the requested measurements are dedicated measurements and that UE 8 is required to make the requested measurements and report the measurement results to the serving macro cell NB 2 as soon as possible irrespective of whether or not the measurement results fulfill the above-mentioned measurement report triggering event or whether or not UE 8 is currently in a reporting period.

Once the UE 8 has made the requested measurements, UE 8 sends a dedicated neighbor cells measurement report message to the serving macro cell NB 2 (STEP 620). The dedicated neighbor cells measurement report message includes the IDs of macro cells for which UE 8 has made measurements and the measured RSRP values for those macro cells.

Based on a comparison of (i) the RSRP values contained in the dedicated measurement configuration message received from UE and (ii) the RSRP values included in the small cell condition report messages 800 (received from the small cells 6 either directly or via the MME or O&M), the serving macro cell NB 2 determines whether or not any of the small cell for which it has received small cell condition report messages are in the vicinity of UE 8 (STEP 622). The comparison may be realized by using a predetermined algorithm. If the comparison result indicates that UE 8 is in the vicinity of a small cell, the process moves to STEP 624; otherwise, the process terminates until there is fresh data to repeat STEP 612.

At STEP 624: the serving macro cell NB 2 transmits a measurement configuration message to UE 8 including an indication of any necessary measurement gaps for the small cell determined to be in the vicinity of UE 8.

UE 8 makes measurements of transmissions made by the small cell for which it has received said measurement configuration message from the serving macro cell NB 2; and in response to a handover triggering event (A3 event) in relation to the small cell, UE 8 transmits back to the serving macro cell NB 2 a measurement report including an indication of a physical cell identifier (PCI) (STEP 626); and the handover procedure continues in the conventional way.

In the event that a small cell NB 6 is to be shut down or deactivated, then as shown in FIG. 7, that small cell NB automatically sends a small cell release message in advance to the MME or O&M via the backhaul link (STEP 702). The small cell release message at least includes the cell global ID of the small cell. It may also include other information that should be sent to MME or O&M and, as mentioned below, relevant macro cell NBs 2. The MME or O&M forwards the small cell release message to those macro cell NBs to which it has previously sent a small cell condition report message for the small cell to which the small cell release message relates (STEP 704). In contrast to the technique illustrated in FIG. 5, the serving macro cell NB 2 does not forward the small cell release message to any UE 8; this is not necessary because the serving macro cell NB also does not forward small cell condition report messages 800 to the UE in this technique according to Example 2.

The above-described techniques have the advantage that they do not require UE 8 to make regular measurements of transmissions made by small cells and make regular reports of those measurements to the serving macro cell NB 2. Such regular measurements could involve significant power consumption at UE 8 (particularly, where the group of transmission frequencies employed by the small cells are different to the group of transmission frequencies employed by the macro cells), and the regular reporting of measurements of small cell reference signals from UE 8 to the serving macro cell NB 2 would require a significant amount of the finite radio resources available to transmissions to or from the serving macro cell NB.

Also, the above-described techniques are effective irrespective of the access mode for the small cell, i.e. irrespective of whether the small cell is a CSG cell, an open cell or a hybrid cell.

The small cells mentioned above could, for example, be femtocell or picocells, or other kinds of cells characterised by a smaller coverage area than the macro cells. Such small cells can be used in residential settings, business settings, or other locations where user population density is relatively high (hotspots). The small cells could be used in areas (such as indoor areas) where access to macro cells can be difficult, or in overload areas where they can relieve the burden on the macro cells.

The above-described operations may require data processing in the various entities. The data processing may be provided by means of one or more data processors. Similarly various entities described in the above embodiments may be implemented within a single or a plurality of data processing entities and/or data processors. Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a server.

For example the embodiments of the invention may be implemented as a chipset, in other words a series of integrated circuits communicating among each other. The chipset may comprise microprocessors arranged to run code, application specific integrated circuits (ASICs), or programmable digital signal processors for performing the operations described above.

Embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

In addition to the modifications explicitly mentioned above, it will be evident to a person skilled in the art that various other modifications of the described embodiment may be made within the scope of the invention.

1. A method comprising: comparing (a) measurements made at the first access node of transmissions made by a plurality of other access nodes against (b) measurements made at the communication device of transmissions made by said plurality of other access nodes; and deciding whether or not to select said first access node as a handover candidate for said communication device based at least partly on the result of said comparison.

2. A method according to claim 1, wherein said plurality of other access nodes operate at the same group of transmission frequencies as an access node currently serving the transmission device, and said first access node operates at a group of transmission frequencies different to that of said access node currently serving said communication device.

3. A method comprising: making measurements at a first access node of transmissions made by a plurality of other access nodes; and sending information about said measurements to one or more other network nodes for use in determining the proximity of said first access node to a communication device.

4. A method according to claim 3, further comprising: also sending from said first access node to said one or more other network nodes information about the transmission frequencies employed by said first access node and closed subscriber group (CSG) related parameters about said first access node if said first access node happens to belong to a CSG.

5. A method according to claim 3, wherein said plurality of other access nodes operate at the same group of transmission frequencies as an access node currently serving the transmission device, and said first access node operates at a group of transmission frequencies different to that of said access node currently serving said communication device.

6. A method according to claim 3, further comprising: sending from said first access node to said one or more other network nodes an advance indication that the first access node will become unavailable as a potential handover target.

7. A method comprising: receiving at a communication device information about measurements made at a first access node of transmissions made by a plurality of other access nodes, and making measurements at said communication device of transmissions made by said plurality of other access nodes; and deciding whether to select said first access node as a handover candidate for said communication device based at least partly on a comparison of said measurements made at a first access node and said measurements made at said communication device.

8. A method comprising: making at a communication device measurements of transmissions made by a plurality of access nodes identified in a request received from an access node serving said communication device; transmitting information about said measurements to said access node serving said communication device for use in determining the proximity of said communication device to a first access node not included in said plurality of access nodes.

9. A method according to claim 7, wherein said plurality of access nodes operate at the same group of transmission frequencies as an access node currently serving the transmission device, and said first access node operates at a group of transmission frequencies different to that of said access node currently serving said communication device.

10. A method comprising: receiving information about measurements made at a communication device of transmissions made by at least an access node serving said communication device, and receiving information about measurements made at a first access node of transmissions made by at least said serving access node; and based at least partly on a comparison of said measurements made at said communication device and said measurements made at said first access node, deciding whether to provide communication device with information for determining proximity of said communication device to said first access node.

11. A method according to claim 10, wherein said first access node operates at a group of transmission frequencies different to that of said access node serving said communication device.

12. A method comprising: receiving information about measurements made at a communication device of transmissions made by a plurality of access nodes, and receiving information about measurements made at a first access node of transmissions made by said plurality of access nodes; and based at least partly on a comparison of said measurements made at said communication device and said measurements made at said first access node, deciding whether to provide said communication device with information for making handover measurements in relation to said first access node.

13. A method according to claim 12, wherein said plurality of access nodes operate at the same group of transmission frequencies as an access node currently serving the transmission device, and said first access node operates at a group of transmission frequencies different to that of said access node currently serving said communication device.

14-32. (canceled)

33. A method according to claim 8, wherein said plurality of access nodes operate at the same group of transmission frequencies as an access node currently serving the transmission device, and said first access node operates at a group of transmission frequencies different to that of said access node currently serving said communication device.
